(19) United States
(12) Patent Application Publication
(10) Pub. No.: US 2015/0150300 A1
(43) Pub. Date: Jun. 4, 2015

(54) MOULD FOR FOOD PRODUCTS

(71) Applicant: PAVONI ITALIA SPA, SUISIO (BG) (IT)

(72) Inventor: Corinna RAINERI, BERGAMO (IT)

(21) Appl. No.: 14/548,877

(22) Filed: Nov. 20, 2014

(30) Foreign Application Priority Data
Nov. 29, 2013 (IT) MI 2013 A 001994

(51) Int. Cl. A23P 1/10

(52) U.S. Cl. CPC A23P 1/105

(57) ABSTRACT

A mould is provided, made of a flexible material, in particular an elastomeric or silicone material, having a body (1) comprising one or more aligned cavities (3) designed to house a food product, said cavities each featuring a lateral opening (4) connected with a portion (5) for supporting a splint or a stick, said mould featuring a hinged sealing appendage (2) with said body being designed to seal the opening of said cavity, thus forming a channel designed to house and hold the splint or the stick in position.

This application claims priority from Italian application no. MI 2013 A 001994 filed Nov. 29 2013.

The present invention relates to a mould for food products provided with a support, in particular a splint or a stick (which may have different cross-sections and shapes) made of a suitable material, for example wood or plastic; the food products may be, for example, ice creams, ice lollies, sweet or savoury products suitable to be cooked and/or frozen. According to one aspect of the invention, the products in question are prepared using a paste or a fluid which undergoes solidification or hardening—by either cooking or freezing—once placed in the mould.

Moulds of this type are commonly made of a flexible material, for example an elastomeric material, and very frequently silicone, which offers the advantage of being perfectly suitable for food use and able to maintain its strength and flexibility within a wide range of temperatures, ranging from freezing temperatures to those used in cooking.

In the case of food supported on a splint or a stick, such as those stated above, moulds made of the flexible material have advantageously replaced the rigid variety which posed problems when removing the product from the mould and, in general, needed to be positioned vertically, with the product upside down, as well as requiring external support structures until the product had hardened. To allow the insertion of the support into the moulds made of silicone or suchlike, several solutions are adopted, whereas in those moulds, in general, the support is maintained in a horizontal position and the product is removed in a transverse direction to the support. For example, a mould has been made with a cavity to house the product which is sealed laterally by a membrane with a hole designed to house the stick. This solution renders product removal manoeuvres difficult, as the stick needs to be contextually slid out of the hole from the inside of the cavity, which usually means the product is handled not only by the stick, but also by the food part. This slows down operations and generates a risk of breakage of or damage to the product, as well as constituting a possible hygiene problem if the operation is not carried out with gloves on. Furthermore, the thin perforated membrane does not provide a proper seal around the stick, especially with very liquid products, or if one wishes to insert the support after the product has been placed in the cavity, such placement being generally easier without the stick present. This leads to the product leaking out considerably and possible consequent dirtying.

Other solutions envisage the use of removable parts to close the cavity and to provide, in cooperation with the rest of the mould, a seat that houses a part of the support outside the cavity of the mould. The positioning of these parts is not always quick and easy, given the flexibility of the mould, and inaccuracies are often possible, accompanied by leakage of the product if liquid and possible abnormalities in terms of shape of the finished product. To facilitate the positioning, one expedient to which recourse is often made is the production of the removable part using a more rigid material than that of the mould, thereby making it more expensive to manufacture and not obviating all the possible positioning errors. Furthermore, the removable part may also get lost.

The problems outlined above have now been solved using a mould made of flexible material, in particular elastomer or silicone, for food products, in particular, sorbets, ice creams, ice lollies, frozen desserts, and savoury products, to be cooked or frozen, having a body comprising one or more aligned cavities designed to house a food product, said cavities each featuring a lateral opening connected with a portion for supporting a splint or a stick, said mould featuring a sealing appendage, hinged with said body, designed to seal the opening of said cavity, thus forming a channel designed to house and hold the splint or the stick in position. Preferably, said sealing appendage is hinged to an edge of said body and said cavities are in an opposing position to said edge with respect to said supporting portion. According to a further preferred aspect, said channel formed—when the sealing appendage is in such a position as to seal the opening—connects the interior of the cavity with the exterior, said mould having a hole in correspondence with the edge where the sealing appendage is hinged and permitting the insertion of the splint or the stick in this position.

The contents of the claims appended hereto constitute a particular aspect of the invention.

The present invention will now be better illustrated in a more detailed fashion by means of the description of a preferred embodiment, provided in the form of a non-limiting example, with respect to the scope of protection offered by the claims, with the help of the accompanying drawings, in which:

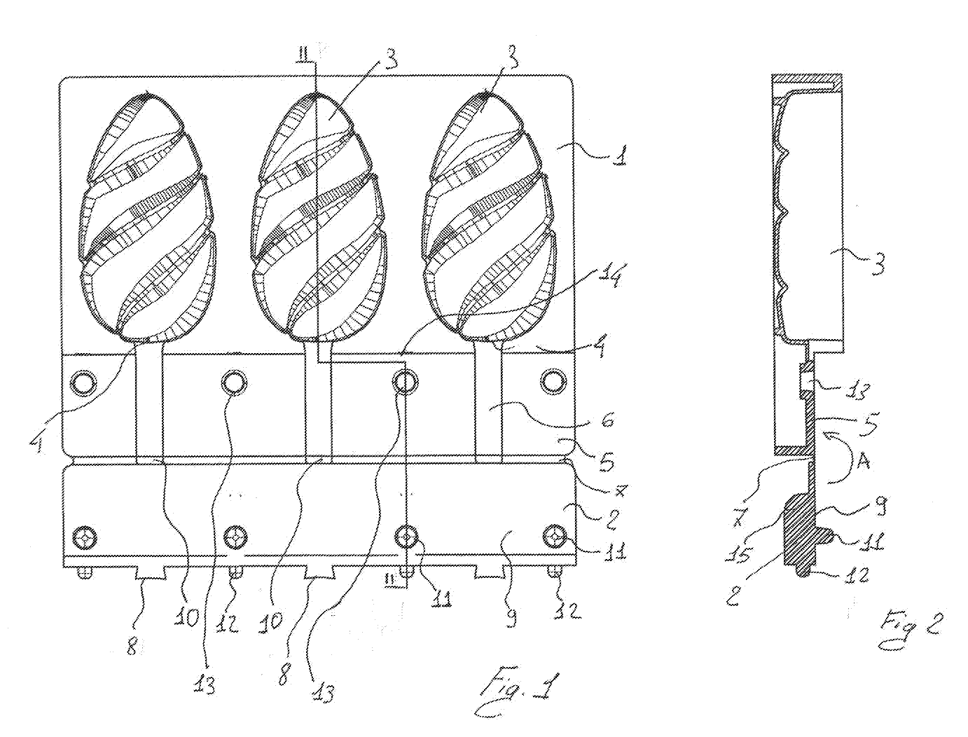

FIG. 1 shows, schematically, a plan view of the mould according to the present invention.

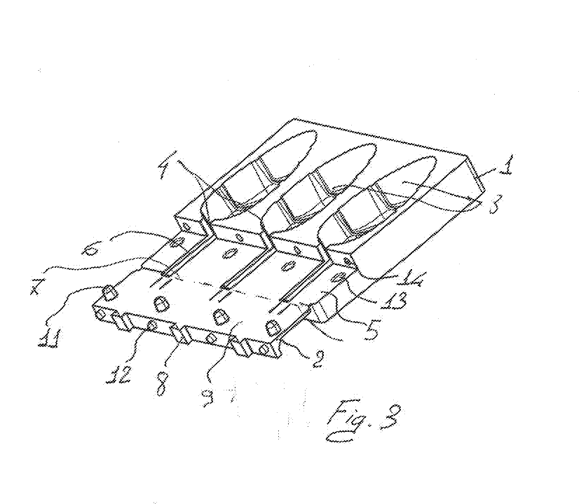

FIG. 2 shows, schematically, a sectional view according to the plane II-II of FIG. 1;

FIG. 3 shows, schematically and from a perspective view, the mould in FIGS. 1 and 2.

With reference to the figures, the mould has a body 1, onto which a sealing appendage 2 is hinged.

The body features a cavity 3 designed to accommodate the product while still liquid and give form to the finished product. The number of the cavities can be variable depending on the requirements and the use for which the mould is intended. Each cavity has an opening 4 designed to allow a splint or a stick to protrude sufficiently inside the cavity. A support portion 5, is positioned adjacent to the openings 4 and is designed to support the sticks. According to a possible embodiment, the support portion may feature seats 6 for housing the sticks.

As said, the closing appendage 2 is hinged to the body 1. According to a preferred aspect, the appendage and the body form a single body made of a flexible material, such as silicone or elastomer, suitable for food use.

According to a further preferred aspect, they are joined by a membrane 7, which is clearly visible in FIG. 3 in particular and which allows the appendage 2 to be bent over the body 1 in the direction shown by arrow A. In this way, the sealing appendage, appropriately shaped, can seal the openings 4. According to a preferred aspect, it is shaped in an appropriate manner, in correspondence of the sections 8, which are located in correspondence with the openings 4, so as to seal them and cooperate with the surface of the body in shaping the internal surface of the cavity, in a manner corresponding to the shape of the desired product.

In the closed position, the appendage 2 cooperates with the support portion 5, so as to create said channels designed to house and hold the sticks in position. In the case exemplified, the surface 9 of the sealing appendage marks out said channel with the seats 6. Other solutions are possible, such as providing the seats on the sealing appendage, instead of the support, or on both, or making parts in relief on one or both of the opposing surfaces. The solution exemplified offers the advantage of allowing, if so desired, the stick to be positioned even when the appendage is not in the sealed position.

Preferably, it is possible for the splint or stick to be inserted when the appendage is in the sealed position. In the event that the appendage is hinged in a position opposite to the openings with respect to the support portion, it is possible for the channels to be open in correspondence with said hinging. For example, the membrane that acts as a hinge, can be cut away in correspondence with such channels, creating the holes 10. Obviously, with the appendage in the sealed position, these holes will constitute the openings through which the splints or sticks can be inserted.

Locking means are preferably envisaged in order to keep the appendage in the sealed position.

Interlocking systems may be envisaged for example, such as the first pairs of protuberances 11 and second pairs 12, which are designed to interlock, respectively, inside the holes 13 and the recesses 14, the positioning and the interlocking being possible thanks to the elasticity of the material of which the mould is made. According to another preferred aspect, the first protuberances only may be present, having the respective holes (which may also be simply recesses), which give sufficient stability to the seal, together with greater simplicity of use.

Other interlocking arrangements may also be adopted, for example by exchanging the holes and protuberances with holes and cavities or other devices, or by providing different types of means based on the knowledge of those skilled in the art.

In the case exemplified, the ribs 15 shown in FIG. 2 have been made to confer to the appendage stability and rigidity. They could also constitute a valid holding point for opening and closing operations. Other ribs or devices to confer stability may also be envisaged according to requirements.

The position of the hinging—in particular if such hinging essentially concerns all or a large part of the mutual rotation axis of the appendage and the body—confers precision to the closing operation and prevents a different folding of the two parts leading to an imperfect seal due to the elasticity of the materials, and the accompanying material leakage and deformity of the product obtained, even during quick operation.

The opening of the appendage completely releases the openings 4 and allows easy removal of the finished products without excessive deformation of the mould or manoeuvres that could damage the products just made. In particular, the product can be extracted by holding it just by the splint or stick, and with minimal deformation of said mould, solely to detach said product from surfaces of the cavity, unlike that which occurs with the existing solutions discussed above.

The splint or the stick may be made of any appropriate material, such as those already mentioned above. Likewise, the shape of the stick may be of any known type, for example cylindrical.

When designing the mould, one will need to take into account the type or types of splint or stick with which the mould is intended to work.

According to a preferred aspect of the invention, as occurs in the mould exemplified, the mould allows the insertion of the splint or stick when the appendage is in the sealed position; the insertion depth can be decided by the user according as desired and specifically required for the product, by sliding the splint or the stick into the channel formed as described above.

The production of the mould and the various types of devices or variations can be devised, based on that which is stated above and according to the knowledge of those skilled in the art, without departing from the scope of protection of the present application.

1. A mould, made of a flexible material, in particular an elastomeric or silicone material, having a body (1) comprising one or more aligned cavities (3) designed to house a food product, said cavities each featuring a lateral opening (4) connected with a portion (5) for supporting a splint or a stick, said mould featuring a sealing appendage (2), hinged with said body, being designed to seal the opening of said cavity, thus forming a channel designed to house and hold the splint or the stick in position.

2. A mould according to claim 1, wherein said sealing appendage is hinged to an edge (7) of said body and said cavities are in an opposing position to said edge with respect to said supporting portion.

3. A mould according to claim 1, wherein said channel formed, when the sealing appendage is in such a position as to seal the openings, connects the interior of the cavity with the exterior, said mould having a hole (10) in correspondence with the edge (7) where the sealing appendage is hinged and permitting the insertion of the splint or the stick in this position.

4. A mould according to claim 3, wherein the appendage and the body are made as a single piece and are joined by a membrane (7) which acts as a hinge.

5. A mould according to claim 4 wherein said membrane is interrupted creating holes (10) in correspondence with said channels.

6. A mould according to claim 1 wherein there are locking means envisaged for retaining the appendage in the sealed position.

7. A mould according to claim 6, wherein said means are protuberances (11, 12) and holes (13) or recesses (14) designed for mutual interlocking.
